(19) United States
(12) Patent Application Publication
(10) Pub. No.: US 2011/0306333 A1
(43) Pub. Date: Dec. 15, 2011

(54) Support of multiple 3GPP standards versions

(75) Inventors: Matthew Andrew Yee, Kanata (CA); Susan Ackerman, Kanata (CA)

(73) Assignee: Alcatel-Lucent Canada Inc.

(21) Appl. No.: 12/802,722

(22) Filed: Jun. 10, 2010

(51) Int. Cl. H04W 4/00

(52) U.S. Cl. 455/422.1

(57) ABSTRACT

The preferred methodology involves operating internally at the PCRF node at a highest supported minor version of the 3GPP standards and supporting multiple minor versions of the 3GPP standards at the PCRF node. The preferred methodology may also involve: determining which minor version of the 3GPP standards is used by a component in a network; selecting the minor version of the 3GPP standards supported by the component in the network; and utilizing the minor version of the 3GPP standards supported by the component in the network for sending content and messaging from the PCRF node.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the telecommunications industry. The invention discussed herein is in the general classification of a device capable of operation in a mode compatible with different versions of the 3GPP standards and a method for operating according to different versions of the 3GPP standards at the PCRF node.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Several technical terms and/or phrases will be used throughout this application and merit a brief explanation.

The 3^{rd} Generation Partnership Project (3GPP) attempts to create a uniform third-generation mobile phone system. 3GPP standards are called releases and different functionality is present in the different versions of the releases.

The 3GPP standards continue to evolve and the major releases of the standards can be differentiated using supported features. However, there also may be differences between minor versions of the 3GPP standards that render them incompatible with each other. It is required that a single release of the Policy and Charging Rules Function (PCRF) be used with different networks operating with different minor versions of the standards.

A base transceiver station (BTS or BS) is used between a mobile phone and a network to permit wireless communication. It can be a radio base station (RBS), node B for 3G networks or enhanced node B for long term evolution (LTE) networks.

A global system for mobile communications (GSM) network includes a network and switching subsystem (NSS) with a mobile switching center (MSC) and associated registers (e.g. home location register (HLR) and visitor location register (VLR)), a base station controller (BSC) and multiple BTSs and an operations support system (OSS).

The GSM originally only involved a circuit switched network for voice calls and short messaging services (SMS). However, it was extended to include packet-switched data services via the General Packet Radio Service (GPRS) core network to permit Internet access.

A MSC is the service delivery node for GSM in charge of routing voice calls. The gateway MSC (GMSC) is an MSC that ascertains the location of a subscriber who is being called by checking the HLR. The gateway MSC also interfaces with the Public Switched Telephone Network (PSTN).

The HLR is a central database containing mobile phone subscriber information. A VLR is a temporary database containing information related to mobile phone subscribers that are roaming in an area the VLR serves. Each BTS is served by a VLR.

A gateway GPRS Support Node (GGSN) permits interaction between the GPRS network which is used for transmitting Internet Protocol (IP) packets and external packet switched networks. When a GGSN receives data addressed to a user, it is forwarded to the serving GPRS support node (SGSN) for delivery to the mobile stations in its service area.

System architecture evolution (SAE) is the architecture of 3GPP's LTE wireless communication standard. The evolved packet core (EPC) is the equivalent of GPRS networks and includes a mobile management entity (MME), a serving gateway (SGW), a Public Data Network (PDN) gateway (PGW or PDN GW) and a policy and charging rules function (PCRF) node.

The MME is the control node for the LTE network. It tracks mobile devices and selects the SGW for a mobile device. The SGW sends data packets while the PGW permits the mobile phone to connect to external data networks. The PCRF node is a concatenation of Policy Decision Function (PDF) and Charging Rules Function (CRF).

Currently, all components in a network implement the same or compatible minor versions of the 3GPP standards. New product releases are required to implement the supported 3GPP standards version of the network. However, it is not always possible during trials of product releases (i.e. live deployments) to change product releases. It is also a maintenance issue to have multiple versions of a product for the multiple minor versions of the 3GPP standards. There is no means to distinguish between minor versions of the 3GPP standards and/or determine which minor version is being used in a network component.

Hence, there is a need for a device that efficiently, reliably and affordably permits operation in a mode compatible with different versions of the 3GPP standards and a methodology that permits determination and selection of different versions of the 3GPP standards at the PCRF node.

### SUMMARY OF THE DISCLOSURE

The preferred methodology involves operating internally at the PCRF node at a highest supported minor version of the 3GPP standards. This may include an operation for sending internal messaging and processing data at the PCRF node according to the highest supported minor version of the 3GPP standards.

The preferred methodology may also involve supporting multiple minor versions of the 3GPP standards at the PCRF node; determining which minor version of the 3GPP standards is used by a component in a network; selecting the minor version of the 3GPP standards supported by the component in the network; and utilizing the minor version of the 3GPP standards supported by the component in the network for sending content and messaging from the PCRF node.

Alternatively, the methodology may involve selecting a minor version of the 3GPP standards to be supported by at least one interface component of a PCRF node by a network operator and operating the at least one interface component at the PCRF node at the minor version of the 3GPP standards selected by the network operator.

The preferred device (e.g. PCRF node) includes a memory containing instructions processed by a processor. The instructions may include instructions for operating internally at the PCRF node at a highest supported minor version of the 3GPP standards; sending internal messaging and processing data at the PCRF node according to the highest supported minor version of the 3GPP standards; supporting multiple minor versions of the 3GPP standards at the PCRF node; determining which minor version of the 3GPP standards is used by a component in a network; selecting the minor version of the 3GPP standards supported by the component in the network; and utilizing the minor version of the 3GPP standards supported by the component in the network for sending content and messaging from the PCRF node.

Alternatively, the device may contain instructions for selecting a minor version of the 3GPP standards to be supported by at least one interface component of a PCRF node by a network operator and for operating the at least one interface component at the PCRF node at the minor version of the 3GPP standards selected by the network operator.

Under some applications, embodiments may provide a method that is relatively inexpensive to implement that permits selection of different minor versions of the 3GPP standards for operation at the PCRF node.

Under some applications, embodiments may provide a device and method that are not operationally complex that permit the PCRF to operate in a mode compatible with different minor versions of the 3GPP standards.

Under some applications, embodiments may provide a device and method that efficiently permit selection of different minor versions of the 3GPP standards for operation at the PCRF node.

Under some applications, embodiments may provide a reliable device and method that permit selection of different minor versions of the 3GPP standards for operation at the PCRF node.

Under some applications, embodiments may provide a device and system that are relatively inexpensive to manufacture and deploy that permit selection of different minor versions of the 3GPP standards for operation at the PCRF node.

### BRIEF DESCRIPTION OF THE DRAWINGS

Some embodiments of apparatus and/or methods of the present invention are now described, by way of example only, and with reference to the accompanying drawings, in which:

FIG. 1 depicts a 2G/3G mobile generation network and a LTE network.

FIG. 2 depicts a LTE network and the components of the EPC.

FIG. 3 depicts the SGW of a LTE network handling a mobile device moving from a location serviced by a first eNodeB to a location serviced by a second eNodeB.

FIG. 4 depicts one or more service data flows (SDFs) aggregated and carried over bearers.

FIG. 5 depicts three segments that constitute an end-to-end bearer.

FIG. 6 depicts how the PCRF node interfaces with other EPC elements.

FIG. 7 depicts the dynamic nature of policy and mobility management in a LTE network.

FIG. 8 depicts the method of the preferred embodiment for internal operation at the PCRF node.

FIG. 9 depicts the method of the preferred embodiment for operation of the interface components of the PCRF node.

FIG. 10 depicts the device of the preferred embodiment capable of operating according to different minor versions of the 3GPP standards.

### DETAILED DESCRIPTION OF THE DRAWINGS

The evolved packet core (EPC) is an all-IP mobile core for the long term evolved (LTE) network that involves a converged framework for packet-based real-time and non-real-time services. The EPC is specified by 3GPP Release 8 that was finalized in the first quarter of 2009.

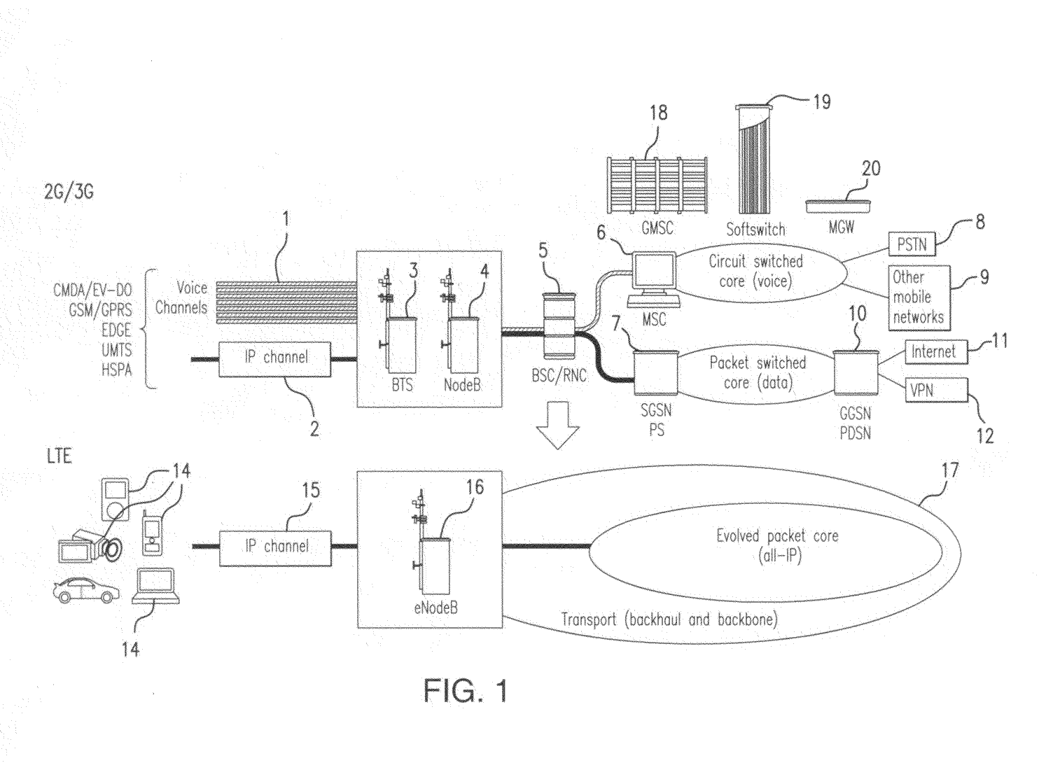

The EPC provides mobile core functionality that in previous mobile generations (e.g. 2G and 3G) has been realized through two separate sub-domains: circuit-switched (CS) for voice and packet-switched (PS) for data. As shown in FIG. 1, in previous mobile generations (e.g. 2G and 3G), both voice channels 1 and IP channels 2 are utilized to connect with a BTS 3 or NodeB 4. This permits transmission to a BSC or RNC 5 connected to a MSC 6 or SGSN 7. The RNC 5 controls the NodeBs that are connected to it and connects to the circuit switched core network through a media gateway (MGW) 20 and MSC 6 and to the SGSN 7 in the packet switched core network. The MSC 6 permits circuit switched traffic to travel to the PSTN 8 or other mobile networks 9. The SGSN 7 permits packet switched traffic to travel to a GGSN 10 and onto the Internet 11 or a Virtual Private Network (VPN) 12. The VPN 12 is an overlay network that permits private data to be sent securely over the Internet. A GMSC 18 responsible for determining which MSC a call recipient is visiting and a softswitch 19 responsible for connecting telephone calls from one phone line to another are also depicted in FIG. 1.

As shown in FIG. 1, in a LTE network, these two distinct mobile core sub-domains used for separate processing and switching of mobile voice and data are unified as a single IP domain (IP channel 15). LTE is an end-to-end all-IP network from mobile handsets and other terminal devices 14 with embedded IP capabilities over IP-based Evolved NodeBs (eNodeBs) 16 (i.e. LTE base stations) and across the EPC 17 and throughout the application domain (both IP Multimedia Subsystem (IMS) and non-IMS).

EPC 17 is essential for end-to-end IP service delivery across the LTE network. The EPC 17 is also instrumental in allowing the introduction of new business models, such as partnering/revenue sharing with third-party content and application providers. EPC 17 promotes the introduction of new innovative services and the enablement of new applications.

EPC 17 addresses LTE requirements to provide advanced real-time and media-rich services with enhanced Quality of Experience (QoE). EPC 17 improves network performance by the separation of control and data planes and through a flattened IP architecture that reduces the hierarchy between mobile data elements (e.g. data connections from eNodeB 16 only traverse through EPC gateways).

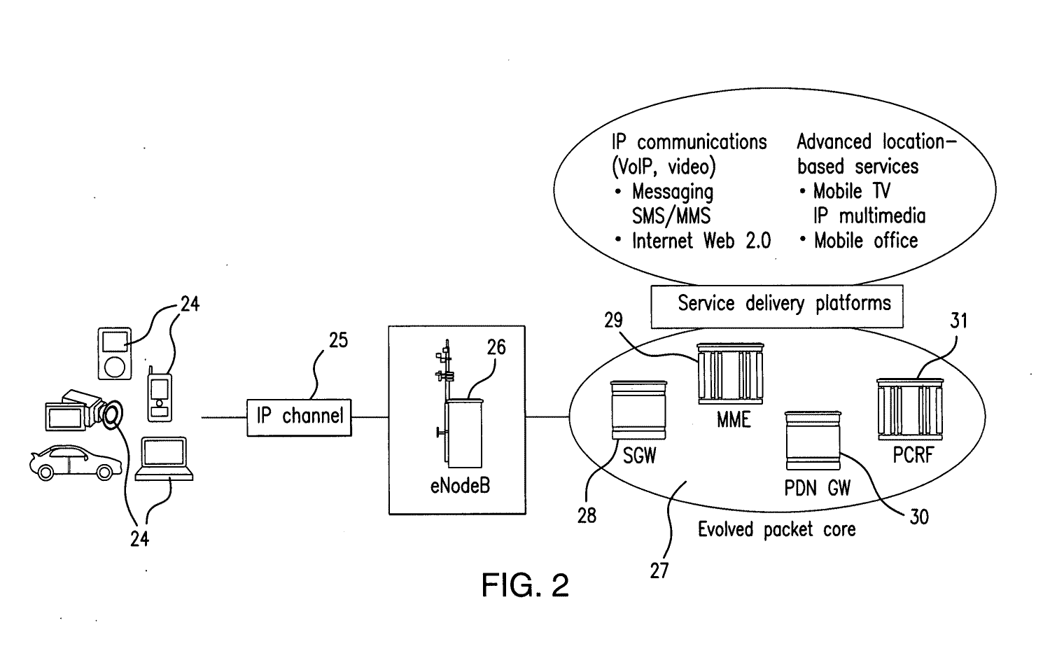

FIG. 2 depicts a LTE network with the components of the EPC. FIG. 2 shows the EPC 27 as a core part of the all-IP environment of the LTE network. In the LTE network, the two distinct mobile core sub-domains used for separate processing and switching of mobile voice and data in 2G/3G networks are unified as a single IP domain (IP channel 25). The LTE network is an end-to-end all-IP network from mobile handsets and other terminal devices 24 with embedded IP capabilities over IP-based Evolved NodeBs 26 and across the EPC 27.

The introduction of the EPC 27 and all-IP network architecture in the mobile network has profound implications on mobile services, as all voice, data and video communications are built on the IP protocol. EPC 27 also permits interworking of the new mobile architecture with previous mobile generations (e.g. 2G or 3G) and the scalability required by each of the core elements to address dynamic terminal mobility and dramatic increases in bandwidth and the number of direct connections to user terminals. The EPC 27 also increases the reliability and availability delivered by each element to insure service continuity.

To address a radically different set of network and service requirements, the EPC 27 must represent a departure from existing mobile networking paradigms. Introduction of EPC 27 with the LTE network in many ways represents a radical departure from previous mobile paradigms. It signals the end of circuit-switched voice. The LTE network uses a new paradigm for voice traffic called Voice-over-IP (VoIP). This ends a period of more than twenty (20) years during which one application dictated the whole network architecture. EPC 27 treats voice as just one of many IP-based network applications, albeit an important one that requires superb packet network performance and one that is responsible for significant operator revenues.

The LTE network must match and exceed the QoE of wireline broadband. This is quite different from providing best-effort and low-speed web browsing or Short Message Service (SMS) which are two data applications for which the existing PS mobile cores are optimized.

In the LTE network, all mobility management is moved into the mobile core and becomes the responsibility of the MME 29. This is a consequence of the split of functions previously performed by the RNC/BSC and NodeB/BTS. The MME 29 requires a control plane capacity that is an order of magnitude larger than the SGSN or PDSN and must insure interworking with 2G/3G legacy mobile systems.

The LTE network must provide superior end-to-end Quality-of-Service (QoS) management and enforcement in order to deliver new media-rich, low-latency and real-time services. There is an expected move from four classes of service (CoS) available in 3G to nine QoS profiles with strict performance targets. This must be achieved while ensuring scalability of users, services and data sessions. In addition, although not a part of the 3GPP Release 8 specification set, deep packet inspection (DPI) and other advanced packet processing are required.

In a LTE network, service control is provided via the Policy and Charging Rules Function (PCRF) 31. This is a change from previous mobile systems, where service control was realized primarily through user equipment (UE) authentication by the network. The PCRF 31 dynamically controls and manages all data sessions and provides appropriate interfaces toward charging and billing systems as well as enables new business models.

The LTE network requires significantly more capacity in both the data plane and control plane. The existing 2G/3G mobile core elements cannot fully address LTE requirements without a series of upgrades to the platforms. Most of the existing platforms are ill-suited for high-capacity packet processing. Scaling the packet processing requirements on these platforms results in higher consumption of system capacity, high latency, low performance and dramatic performance/feature tradeoffs. In some cases, performance drops more than fifty percent (50%) when features like charging are enabled. Legacy core platforms must dramatically change their product architectures to handle LTE, and even with these architectural changes, they are only a stop-gap solution that may require complex upgrade scenarios to address LTE scalability and performance requirements.

While LTE introduces a clear delineation of the data (user) plane and a control plane, it also imposes two sets of distinct technical requirements on the data plane and control plane. The data plane needs to address requirements for high bandwidth, high availability and scalability with aggregate throughput (per gateway) easily reaching over 100 Gb/s (100 gigabits per second). At the same time, the data plane needs to allow unaffected wirespeed performance with sophisticated processing of millions of service data flows and data bearers turned on while being able to provide sophisticated, fine-granular (per-application, per-service, per-user) QoS. The control plane needs to address the requirements for high scalability and high availability of secure mobility and connection management along with highly reliable and scalable network-wide policy and subscriber management.

The EPC is realized through four new elements: Serving Gateway (SGW) 28; Packet Data Network (PDN) Gateway (PGW or PDN GW) 30; Mobility Management Entity (MME) 29; and Policy and Charging Rules Function (PCRF) 31.

While SGW 28, PDN GW 30 and MME 29 were introduced in 3GPP Release 8, PCRF 31 was introduced in 3GPP Release 7. Until recently, the architectures using PCRF 31 have not been widely adopted. The PCRF's interoperation with the EPC gateways and the MME 29 is mandatory in Release 8 and essential for the operation of the LTE.

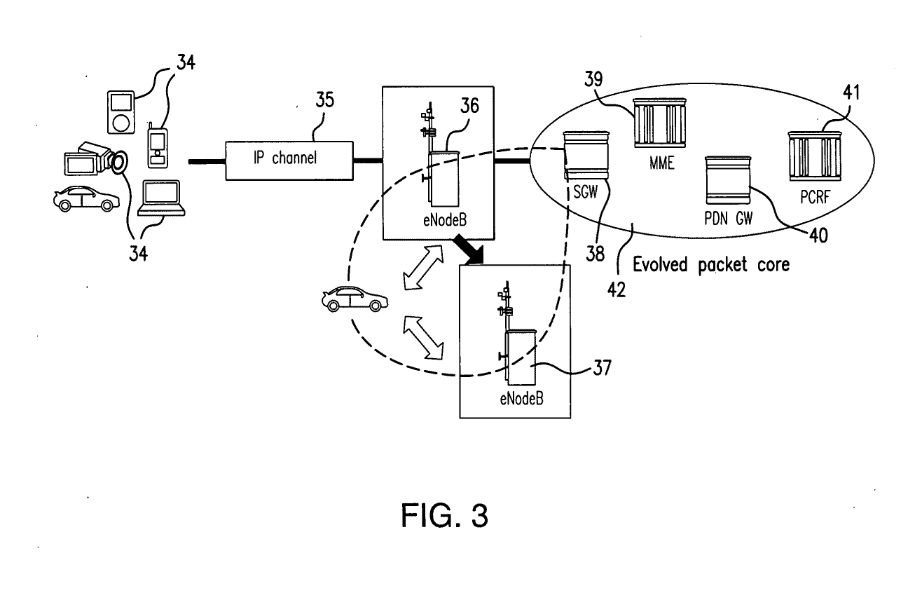

FIG. 3 depicts the SGW of a LTE network handling a mobile device moving from a location serviced by a first eNodeB to a location serviced by a second eNodeB. In the LTE network, the two distinct mobile core sub-domains used for separate processing and switching of mobile voice and data in 2G/3G networks are unified as a single IP domain (IP channel 35). LTE is an end-to-end all-IP network from mobile handsets and other terminal devices 34 with embedded IP capabilities over IP-based Evolved NodeBs 36 and 37 and across the EPC 42. The EPC 42 has a SGW 38, a MME 39, a PDN GW 40 and a PCRF 41.

The SGW 38 is a data plane element whose primary function is to manage user-plane mobility and act as a demarcation point between the RAN and core networks. SGW 38 maintains data paths between eNodeBs 36 and 37 and the PDN GW 40. From a functional perspective, the SGW 38 is the termination point of the packet data network interface toward evolved universal terrestrial radio access network (E-UTRAN). When terminals move across areas served by eNodeB elements 36 and 37 in E-UTRAN, the SGW 38 serves as a local mobility anchor. This means that packets are routed through this point for intra E-UTRAN mobility and mobility with other 3GPP technologies such as 2G/GSM and 3G/UMTS.

Like the SGW 38, the Packet Data Network Gateway (PDN GW) 40 is the termination point of the packet data interface toward the packet data network(s). As an anchor point for sessions toward the external packet data networks, the PDN GW 40 supports: policy enforcement features (e.g. applies operator-defined rules for resource allocation and usage); packet filtering (e.g. deep packet inspection for application type detection); and charging (e.g. per-URL charging).

In LTE, data plane traffic is carried over virtual connections called service data flows (SDFs). SDFs, in turn, are carried over bearers (i.e. virtual containers with unique QoS characteristics).

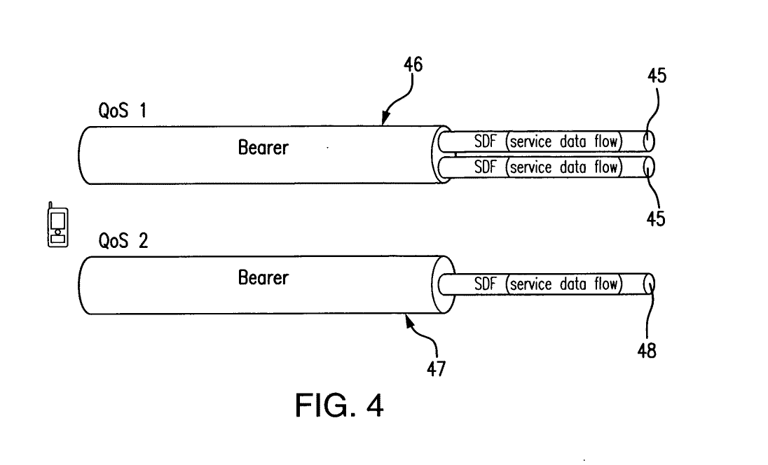

FIG. 4 depicts one or more SDFs aggregated and carried over bearers. Two SDFs 45 are located in bearer 46 and one SDF 48 is located in bearer 47.

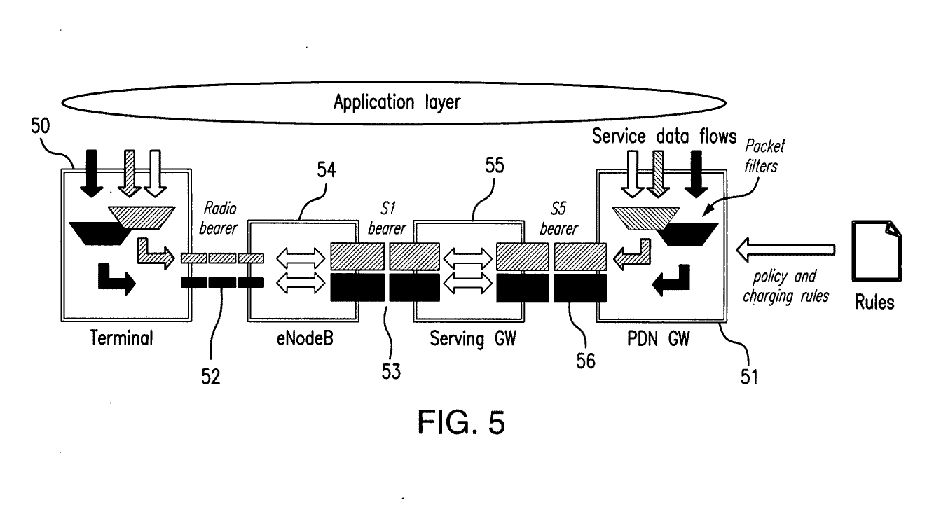

FIG. 5 depicts three segments that constitute an end-to-end bearer. One bearer, a datapath between a UE (terminal) 50 and a PDN GW 51, has three segments: radio bearer 52 between UE (terminal) 50 and eNodeB 54; data bearer 53 between eNodeB 54 and SGW 55 (S1 bearer 53); and data bearer 56 between SGW 55 and PDN GW 51 (S5 bearer 56).

The primary role of the PDN GW 51 is QoS enforcement for each of these SDFs, while SGW 55 focuses on dynamic management of bearers.

As shown in FIG. 3, the Mobility Management Entity (MME) 39 is a nodal element within the EPC 42. MME 39 performs the signaling and control functions to manage the User Equipment (UE)/terminal devices 34 and their access to network connections. The MME 39 also manages the assignment of network resources and the mobility states to support tracking, paging, roaming and handovers. MME 39 controls all control plane functions related to subscriber and session management.

MME 39 manages thousands of eNodeB elements, which is one of the key differences from requirements previously seen in 2G/3G (on RNC/SGSN platforms). The MME 39 is the key element for gateway selection within the EPC 42 (i.e. selection of SGW and PDN GW). The MME 39 also performs signaling and selection of legacy gateways for handovers for other 2G/3G networks. The MME 39 also performs the bearer management control functions to establish the bearer paths that the terminal devices utilize.

The MME 39 supports end-user authentication as well as initiation and negotiation of ciphering and integrity protection algorithms. The MME 39 also handles terminal-to-network sessions by controlling all the signaling procedures used to set up packet data context and negotiate associated parameters like QoS. The MME 39 further is responsible for idle terminal location management by using a tracking area update process to enable the network to join terminals for incoming sessions.

The major improvement provided in Release 7 of the 3GPP standards, in terms of policy and charging, is the definition of a new converged architecture to allow the optimization of interactions between the Policy and Rules functions. Release 7 of the 3GPP standards involves a new network node, Policy and Charging Rules Function (PCRF) node 41, which is a concatenation of Policy Decision Function (PDF) and Charging Rules Function (CRF).

Release 8 further enhances PCRF functionality by widening the scope of the Policy and Charging Control (PCC) framework to facilitate non-3GPP access to the network (e.g. WiFi or fixed IP broadband access). In the generic policy and charging control 3GPP model, the Policy and Charging Enforcement Function (PCEF) is the generic name for the functional entity that supports service data flow detection, policy enforcement and flow-based charging. The Application Function (AF) represents the network element that supports applications that require dynamic policy and/or charging control. In the IMS model, the AF is implemented by the Proxy Call Session Control Function (P-CSCF).

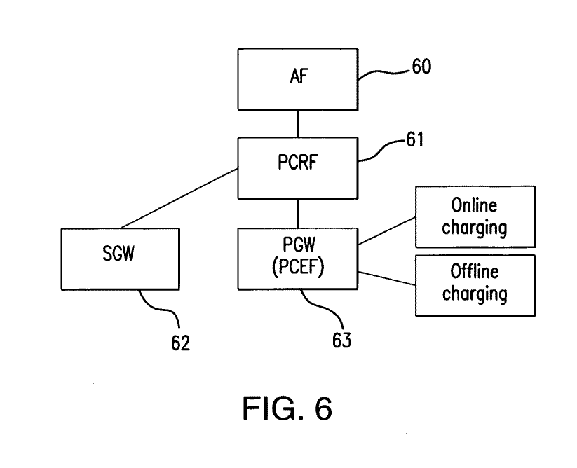

FIG. 6 depicts how the PCRF node interfaces with other EPC elements. The PCRF node 61 connects to the AF element 60, the PGW 63 and the SGW 62.

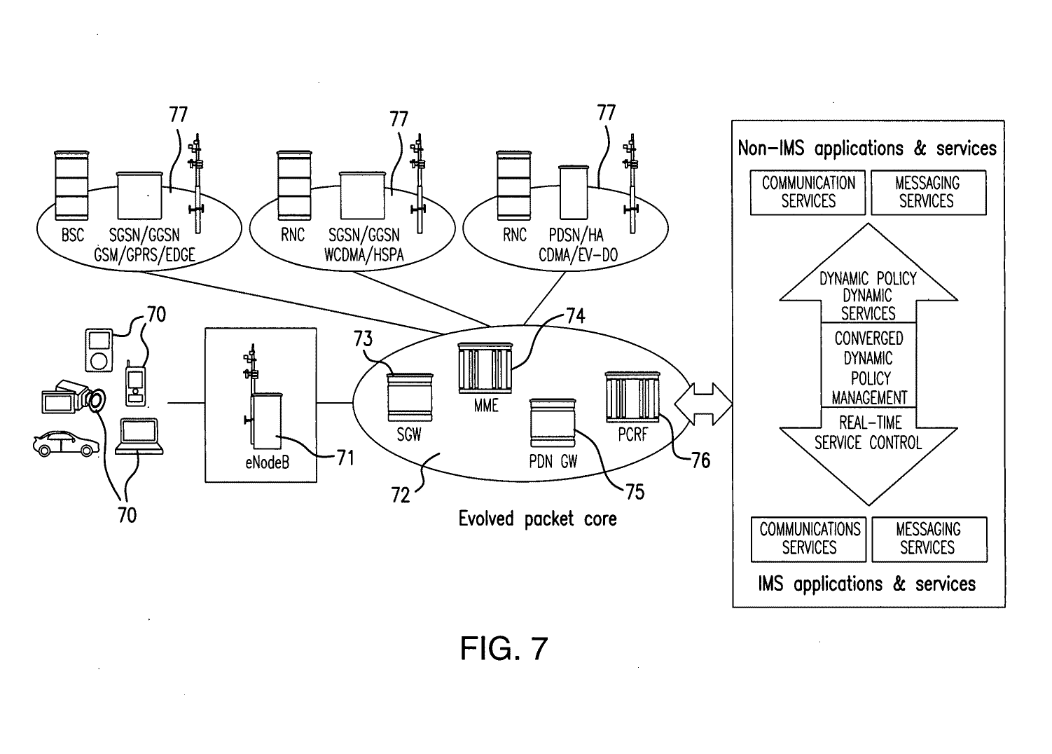

FIG. 7 depicts the dynamic nature of policy and mobility management in a LTE network. The LTE network of FIG. 7 is an end-to-end all-IP network from mobile handsets and other terminal devices 70 with embedded IP capabilities over IP-based Evolved NodeBs 71 and across the EPC 72. The EPC 72 has a SGW 73, a MME 74, a PDN GW 75 and a PCRF 76. The EPC 72 is capable of connecting to a variety of mobile networks 77 and performing dynamic management of mobility, data sessions and network policies.

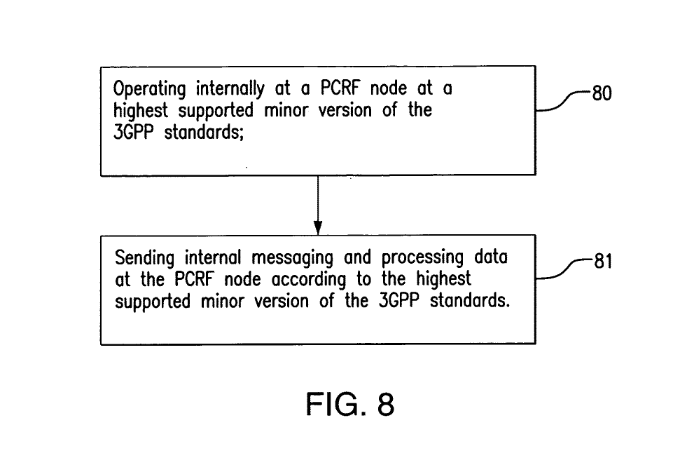

FIG. 8 depicts the method of the preferred embodiment for internal operation at the PCRF node. The preferred methodology involves operating internally at a PCRF node at a highest supported minor version of the 3GPP standards 80. The highest supported minor version of the 3GPP standards is usually considered the most recent/up-to-date minor version of the 3GPP standards that a given PCRF node supports. Operating internally at a PCRF node at the highest supported minor version of the 3GPP standards may include an operation for sending internal messaging and processing data at the PCRF node according to the highest supported minor version of the 3GPP standards 81.

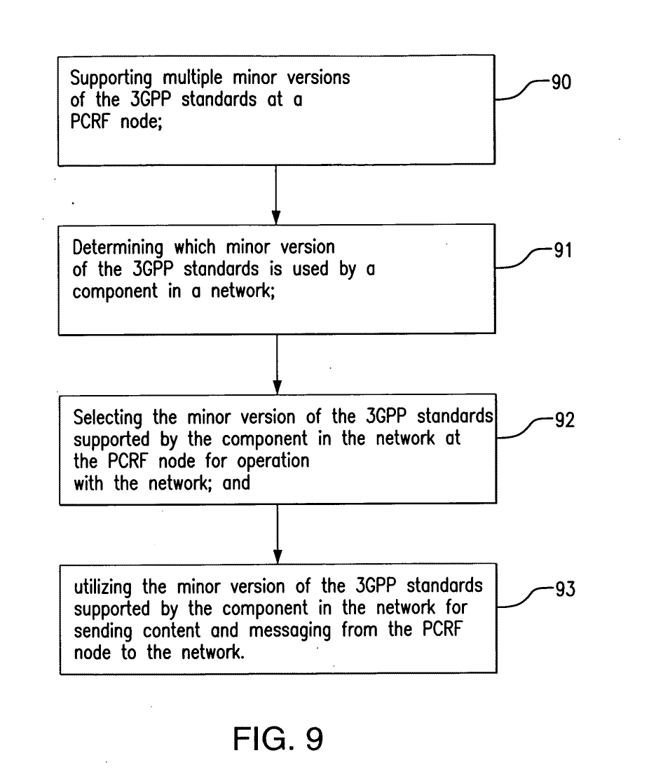

FIG. 9 depicts the method of the preferred embodiment for operation of the interface components of a PCRF node. An operation for supporting multiple minor versions of the 3GPP standards at the PCRF node 90 is performed. An operation for determining which minor version of the 3GPP standards is used by a component in a network at the PCRF node 91 is performed. The operation for determining which minor version of the 3GPP standards is used by a component in a network at the PCRF node may involve receiving a compliance message at the PCRF node from the component indicating that it is using a certain minor version of the 3GPP standards. The operation for determining which minor version of the 3GPP standards is used by a component in the network may alternatively involve sending a message to the component from the PCRF node to determine the minor version of the 3GPP standards being utilized by the component and receiving a response to the message at the PCRF node indicating the version of the 3GPP standards being utilized by the component.

An operation for selecting the minor version of the 3GPP standards supported by the component in the network at the PCRF node for operation with the network 92 is also performed. An operation for utilizing the minor version of the 3GPP standards supported by the component in the network for sending content and messaging from the PCRF node to the network 93 is performed.

Alternatively, an operation for selecting a minor version of the 3GPP standards to be supported by at least one interface component of a PCRF node by a network operator is performed. An operation for operating the at least one interface component at the PCRF node at the minor version of the 3GPP standards selected by the network operator is performed.

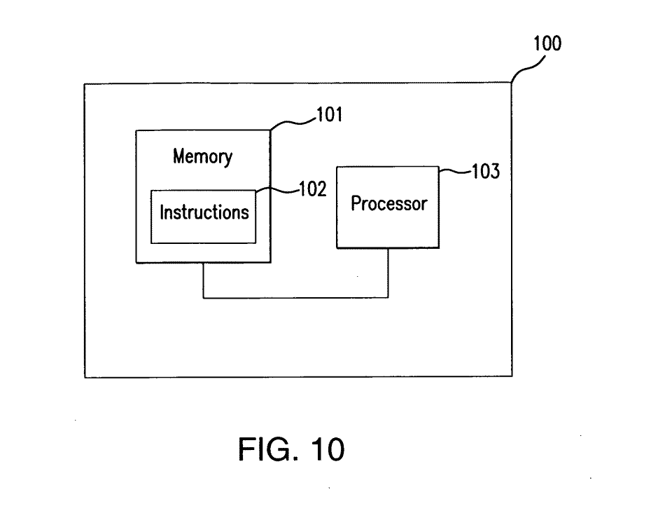

FIG. 10 depicts the device of the preferred embodiment capable of operating according to different minor versions of the 3GPP standards. The device (e.g. PCRF node) 100 includes a memory 101 containing instructions 102 processed by a processor 103. The instructions may include instructions for operating internally at the PCRF node at a highest supported minor version of the 3GPP standards; sending internal messaging and processing data at the PCRF node according to the highest supported minor version of the 3GPP standards; supporting multiple minor versions of the 3GPP standards at the PCRF node; determining which minor version of the 3GPP standards is used by a component in a network; selecting the minor version of the 3GPP standards supported by the component in the network for operation with the network; and utilizing the minor version of the 3GPP standards supported by the component in the network for sending content and messaging from the PCRF node to the network.

The instructions for determining which minor version of the 3GPP standards is used by a component in a network may further involve instructions for receiving a compliance message at the PCRF node from the component indicating that it is using a certain minor version of the 3GPP standards. The instructions for determining which minor version of the 3GPP standards is used by a component in the network may alternatively involve instructions for sending a message to the component from the PCRF node to determine the minor version of the 3GPP standards being utilized by the component and instructions for receiving a response to the message at the PCRF node indicating the version of the 3GPP standards being utilized by the component.

Alternatively, the device may contain instructions for selecting a minor version of the 3GPP standards to be supported by at least one interface component of a PCRF node by a network operator and for operating the at least one interface component at the PCRF node at the minor version of the 3GPP standards selected by the network operator.

It is contemplated that the method described herein can be implemented as software, including a computer-readable medium having program instructions executing on a computer, hardware, firmware, or a combination thereof. The method described herein also may be implemented in various combinations on hardware and/or software.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A method for operation at a policy and charging rules function (PCRF) node of an evolved packet core (EPC) in a long term evolution (LTE) network comprising the steps of:
(a) operating internally at the PCRF node at a highest supported minor version of the 3^{rd} Generation Partnership Project (3GPP) standards; and
(b) supporting multiple minor versions of the 3GPP standards at the PCRF node.

2. The method of claim 1 wherein operating internally at the PCRF node at the highest supported minor version of the 3GPP standards involves sending internal messaging at the PCRF node according to the highest supported minor version of the 3GPP standards.

3. The method of claim 1 wherein operating internally at the PCRF node at the highest supported minor version of the 3GPP standards involves processing data internally at the PCRF node according to the highest supported minor version of the 3GPP standards.

4. The method of claim 1 further comprising the step of
determining which minor version of the 3GPP standards is used by a component in the network at the PCRF node.

5. The method of claim 4 wherein determining which minor version of the 3GPP standards is used by the component in the network may further involve receiving a compliance message at the PCRF node from the component indicating that the component is using a certain minor version of the 3GPP standards.

6. The method of claim 4 wherein determining which minor version of the 3GPP standards is used by the component in the network may further involve sending a message to the component from the PCRF node to determine the minor version of the 3GPP standards being utilized by the component and receiving a response to the message at the PCRF node indicating a certain minor version of the 3GPP standards is being utilized by the component.

7. The method of claim 4 further comprising the step of:
selecting the minor version of the 3GPP standards supported by the component in the network at the PCRF node for operation with the network.

8. The method of claim 7 further comprising the step of:
utilizing the minor version of the 3GPP standards supported by the component in the network for sending content and messaging from the PCRF node to the network.

9. A method for operation at a policy and charging rules function (PCRF) node of an evolved packet core (EPC) in a long term evolution (LTE) network comprising the steps of:
(a) operating internally at the PCRF node at a highest supported minor version of the 3^{rd} Generation Partnership Project (3GPP) standards;
(b) supporting multiple minor versions of the 3GPP standards at the PCRF node; and
(c) selecting a minor version of the 3GPP standards to be supported by at least one interface component of the PCRF node by a network operator.

10. The method of claim 9 further comprising the step of:
operating the at least one interface component at the PCRF node according to the minor version of the 3GPP standards selected by the network operator.

11. A device capable of operating according to different minor versions of the 3^{rd} Generation Partnership Project (3GPP) standards comprising:
(a) a memory containing a set of instructions; and
(b) a processor for processing the set of instructions wherein the set of instructions include instructions for operating internally at a highest supported minor version of the 3GPP standards and supporting multiple minor versions of the 3GPP standards.

12. The device of claim 11 wherein the set of instructions for operating internally at the highest supported minor version of the 3GPP standards involve instructions for sending internal messages according to the highest supported minor version of the 3GPP standards.

13. The device of claim 11 wherein the set of instructions for operating internally at the highest supported minor version of the 3GPP standards involve instructions for processing data internally according to the highest supported minor version of the 3GPP standards.

14. The device of claim 11 wherein the set of instructions further include instructions for determining which minor version of the 3GPP standards is used by a component in a network.

15. The device of claim 14 wherein the instructions for determining which minor version of the 3GPP standards is used by the component in the network include instructions for receiving a compliance message from the component indicating that the component is using a certain minor version of the 3GPP standards.

16. The device of claim 14 wherein the instructions for determining which minor version of the 3GPP standards is used by the component in the network include instructions for sending a message to the component to determine the minor version of the 3GPP standards being utilized by the component and receiving a response to the message indicating a certain minor version of the 3GPP standards is being utilized by the component.

17. The device of claim 14 wherein the set of instructions further include instructions for selecting the minor version of the 3GPP standards supported by the component in the network for operation with the network.

18. The device of claim 17 wherein the set of instructions further include instructions for utilizing the minor version of the 3GPP standards supported by the component in the network for sending content and messaging to the network.

19. The device of claim 11 wherein the set of instructions further include instructions for selecting a minor version of the 3GPP standards to be supported by at least one interface component by a network operator.

20. The device of claim 19 wherein the set of instructions further include instructions for operating the at least one interface component at the minor version of the 3GPP standards selected by the network operator.
